(19) United States
(12) Patent Application Publication
(10) Pub. No.: US 2013/0144733 A1
(43) Pub. Date: Jun. 6, 2013

(54) METHOD AND SYSTEM FOR ELECTRONIC NATIONAL FINANCIAL INSTITUTION GIFT CARD CREATION AND REDEMPTION

(71) Applicant: Leigh M. ROTHSCHILD, Sunny Isles Beach, FL (US)

(72) Inventor: Leigh M. ROTHSCHILD, Sunny Isles Beach, FL (US)

(73) Assignee: ARIEL INVENTIONS, LLC, Sunny Isles Beach, FL (US)

(21) Appl. No.: 13/365,862

(22) Filed: Feb. 3, 2012

Related U.S. Application Data
(63) Continuation-in-part of application No. 13/312,479, filed on Dec. 6, 2011.

(51) Int. Cl. G06Q 20/32

(52) U.S. Cl. 705/17

(57) ABSTRACT

Embodiments of the present invention provide a method, system and a point of sale device for generating and redeeming a virtual gift card. In accordance with an embodiment of the present invention, a virtual gift card associated with a financial institution is generated, the virtual gift card being redeemable at merchants that accept forms of payment associated with a financial institution. The virtual gift card includes a computer readable code that corresponds to a gift card amount. The virtual gift card is sent to a recipient. The computer readable code is received from a wireless mobile device at a point of sale. The gift card amount is applied as at least partial payment for a purchase.

### CROSS-REFERENCE TO RELATED APPLICATION

This application is a continuation-in-part-of U.S. patent application Ser. No. 13/312,479, filed Dec. 6, 2011, entitled METHOD AND SYSTEM FOR ELECTRONIC MERCHANT GIFT CARD CREATION AND REDEMPTION, the entirety of which is incorporated herein by reference.

### STATEMENT REGARDING FEDERALLY SPONSORED RESEARCH OR DEVELOPMENT

n/a

### FIELD OF THE INVENTION

The present invention relates to virtual gift cards, and in particular to a method and system for generating and using a virtual gift card provided by a national credit card company.

### BACKGROUND OF THE INVENTION

Gift cards have become a popular alternative to non-monetary gifts. Most gift cards resemble a plastic credit card with a merchant's logo on one side of the gift card. A customer may buy a gift card at a merchant's store or online at a merchant's website. The customer chooses a gift card design, such as a birthday design or a holiday design from among the group of available physical cards. Some cards come with a pre-loaded value while others are loaded at the point of sale. The purchaser may mail the physical gift card to a recipient or may give the physical gift card to the recipient in person. To redeem the gift card, the recipient can take the physical gift card to the merchant's store and use the gift card to pay for a purchase. In order to determine the gift card's monetary value, a merchant's point of sale terminal reads either a barcode imprinted on the physical gift card or a magnetic strip. The recipient may also redeem the gift card online and use information printed on the physical gift card, such as a gift card number, to pay for a purchase.

Even though millions of dollars are spent every year in gifts cards, a significant percentage of issued gift cards go unused because of the inconvenience associated with having a physical gift card. For example, many gift cards are not redeemed because the recipient misplaces or loses the physical gift card. Other times, a recipient may go to the merchant's store with the intention of redeeming the gift card, only to find out that the gift card has been forgotten at home.

Further, plastic gift cards are not environmentally friendly. The vast majority of plastic gift cards are used only once and then discarded, which contributes to environmental pollution. Some merchants have implemented gift card recycling programs in their stores to encourage customers to recycle redeemed gift cards. However, not many merchants are willing to spend the time and money required to implement these programs.

What is needed is a method and system for generating an environmentally friendly gift card that can be redeemed without requiring the recipient to present a plastic gift card at a point of sale.

### SUMMARY OF THE INVENTION

The present invention advantageously provides a method and system for generating and redeeming a virtual gift card associated with a financial institution that includes a computer readable code, and a point of sale device for receiving the computer readable code. In accordance with one aspect, a method of generating a virtual gift card associated with a financial institution is provided. A virtual gift card that includes a computer readable code corresponding to a gift card amount is generated. The virtual gift card is redeemable at merchants that accept forms of payment associated with a financial institution. The virtual gift card is sent to a recipient. At a point of sale, the computer readable code is received from a wireless mobile device. The corresponding gift card amount is applied as at least partial payment for a purchase.

In accordance with another aspect, a system for generating and redeeming a virtual gift card associated with a financial institution includes a gift card server. The gift card server includes a processor, a transmitter and a receiver. The processor generates a virtual gift card that includes a computer readable code corresponding to a gift card amount. The virtual gift card is redeemable at merchants that accept forms of payment associated with a financial institution. The transmitter sends the virtual gift card to a recipient. To redeem the virtual gift card, the receiver receives the computer readable code from a wireless mobile device at a point of sale. The gift card amount is applied as at least partial payment for a purchase.

According to another aspect, the invention provides a point of sale device that includes a receiver. The receiver is positionable at a point of sale at a merchant store. The receiver receives a computer readable code associated with a virtual gift card associated with a financial institution and redeemable at merchants that accept forms of payment associated with a financial institution. The receiver receives the computer readable code from a wireless mobile device as at least partial payment for a purchase.

According to another aspect, the invention provides a method of generating and redeeming a virtual gift card having a computer readable code corresponding to a gift card amount. The virtual gift card is associated with a financial institution. The virtual gift card is redeemable at merchants that accept forms of payment associated with the financial institution. The virtual gift card is sent to a wireless mobile device. The computer readable code is received from one of the wireless mobile device and a computer connected to the Internet. The corresponding gift card amount is applied as at least partial payment for an online purchase.

In accordance with another aspect, a system for generating and redeeming a virtual gift card includes a gift card server. The gift card server includes a processor, a transmitter and a receiver. The processor generates a virtual gift card associated with a financial institution. The virtual gift card includes a computer readable code corresponding to a gift card amount. The virtual gift card is redeemable at merchants that accept forms of payment associated with a financial institution. The transmitter sends the virtual gift card to a wireless mobile device. To redeem the virtual gift card, the receiver receives the computer readable code from one of the wireless mobile device and a computer connected to the Internet. The gift card amount is applied as at least partial payment for an online purchase.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a diagram of an exemplary system for generating and redeeming a virtual gift card constructed in accordance with the principles of the present invention;

FIG. 2 is a block diagram of an exemplary virtual gift card constructed in accordance with the principles of the present invention;

FIG. 3 is a block diagram of an exemplary gift card server constructed in accordance with the principles of the present invention;

FIG. 4 is a block diagram of an exemplary point of sale device constructed in accordance with the principles of the present invention;

FIG. 5 is a flow chart of an exemplary process for generating, transmitting and redeeming a virtual gift card, in accordance with the principles of the present invention; and

FIG. 6 is a flow chart of an exemplary process for generating a virtual gift card, in accordance with the principles of the present invention.

### DETAILED DESCRIPTION OF THE INVENTION

Embodiments of the present invention provide a method, system and point of sale device for generating and redeeming a virtual gift card provided by a financial institution that includes a computer readable code. In accordance with an embodiment of the present invention, a virtual gift card that includes a computer readable code is generated. The computer readable code corresponds to a gift card amount. The virtual gift card is redeemable at merchants that accept forms of payment associated with a financial institution. The virtual gift card is sent to a recipient. To redeem the virtual gift card, the computer readable code is received from a wireless mobile device at a point of sale. The corresponding gift card amount is applied as at least partial payment for a purchase.

Before describing in detail exemplary embodiments that are in accordance with the present invention, it is noted that the embodiments reside primarily in combinations of apparatus components and processing steps related to implementing a method, a system and a point of sale device for generating and redeeming a virtual gift card including a computer readable code. Accordingly, the method, system, and point of sale device components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

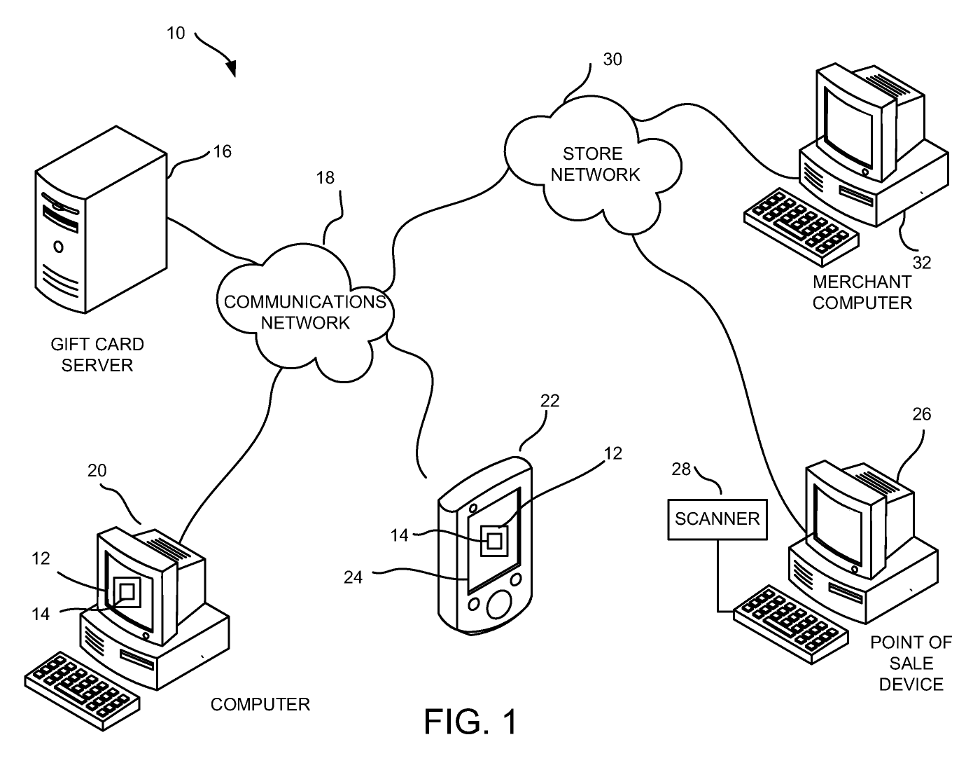

Referring now to the drawing figures in which reference designators refer to like elements, there is shown in FIG. 1 a diagram of an exemplary system constructed in accordance with the principles of the present invention and designated generally as “10”. System 10 generates a virtual gift card 12 associated with a financial institution. Virtual gift card 12 includes computer readable code 14. System 10 includes gift card server 16, which is connected via communications network 18 to computer 20. A purchaser of virtual gift card 12 may use computer 20 to purchase virtual gift card 12 for a recipient. The purchaser may select a template, such as a birthday template, and determine a redemption value of virtual gift card 12. The purchaser may also select a merchant and the financial institution, such as a bank or a credit card company like Visa® or MasterCard®, to associate with virtual gift card 12. To generate virtual gift card 12, computer 20 sends a request to gift card server 16. Gift card server 16 generates virtual gift card 12 and sends virtual gift card 12 to, for example, a recipient's email address, a recipient's telephone number or a recipient's social media identification. Virtual gift card 12 may be redeemable at merchants that accept forms of payment associated with a financial institution, i.e. merchants that accept the corresponding financial institution's cards.

In an exemplary embodiment, virtual gift card 12 is sent to wireless mobile device 22. To redeem virtual gift card 12, a recipient may go to any merchant store that accepts forms of payment associated with the financial institution, such as debit cards and credit cards issued by the financial institution, and display computer readable code 14 on screen 24 of wireless mobile device 22. Point of sale computer 26 at the merchant store may read computer readable code 14 displayed on screen 24 of wireless mobile device 22 using an input device, such as scanner 28. In another exemplary embodiment, point of sale device 26 may receive a wireless communication signal from wireless mobile device 22 that includes computer readable code 14. In another exemplary embodiment, the recipient may redeem virtual gift card 12 online by making an online purchase at a merchant website. By way of example, computer readable code 14 associated with virtual gift card 12 can be typed in by the user at the merchant website, can be scanned by the user or computer readable code 14 can be stored and automatically retrieved by the merchant based, for example, on an account associated with the user. In another exemplary embodiment, virtual gift card 12 may be redeemable at merchants that accept forms of payments issued by a financial institution associated with virtual gift card 12, such as cards provided by the financial institution.

Point of sale computer 26 is connected to store network 30, which is connected to communications network 18. Point of sale computer 26 may send information associated with virtual gift card 12, such as computer readable code 14, to other computers via store network 30 and communications network 18. In another exemplary embodiment, point of sale computer 26 may send computer readable code to at least one of merchant computer 32 and gift card server 16 for validation of virtual gift card 12. Gift card server 16 or merchant computer 32 may validate the purchase by verifying information associated with computer readable code 14. Gift card server 16 or merchant computer 32 may be associated with a national financial institution such as a credit card company like Visa® or MasterCard®.

Virtual gift card 12 may be issued by a financial institution or by a third party. A third party may be a financial institution, such as a bank, a credit card company, or a company affiliated with many merchants, one merchant or no merchants. In one embodiment, virtual gift card 12 may be issued by a financial institution, such as a credit card company, and may be redeemed at a plurality of merchants associated with the financial institution, i.e. merchants that accept the corresponding financial institution's cards. For example, virtual gift card 12 may be issued by Visa® and may be redeemed at merchants nationwide that accept Visa® credit cards as a form of payment. A merchant associated with the financial institution may process virtual gift card 12 as a payment from the financial institution. By way of example, the credit card company may provide payment to a merchant for a purchase made using virtual gift card 12.

Virtual gift card 12 may be redeemed at one merchant or may be redeemed at a plurality of merchants associated with a financial institution. The merchants may accept purchase payments from the financial institution. In an exemplary embodiment, even though virtual gift card 12 was generated to be associated with a particular merchant, virtual gift card 12 may be redeemed at a different merchant. A recipient of virtual gift card 12 may send a request to the third party that issued virtual gift card 12 to change the merchant associated with virtual gift card 12. The third party may redirect funds associated with virtual gift card 12 to the newly requested merchant. A recipient of virtual gift card 12 may also send a request to the third party that issued virtual gift card 12 to associate the virtual gift card 12 with a plurality of merchants, where the plurality of merchants may or may not include the original merchant associated with virtual gift card 12.

Virtual gift card 12 includes computer readable code 14. Computer readable code 14 may be a bar code, or any other machine-readable representation of data. Computer readable code 14 may be any suitable computer readable code, including but not limited to a one dimensional code, a two dimensional code, a multi-dimensional code, a numeric code, a code word, a geometric code, a linear barcode, a matrix barcode, a two dimensional data matrix, an image, or combinations thereof. In an exemplary embodiment, computer readable code 14 may include, for example, digits, characters, symbols, images, a digital signature, a sequence known to the merchant, or other data capable of being associated with a commercial transaction. Computer readable code 14 may also include special position detection patterns embedded in computer readable code 14 to facilitate reading of computer readable code 14.

Computer readable code 14 may include information about the credit card company associated with virtual gift card 12. By way of example, computer readable code 14 may include information associated with a credit card account of the purchaser of virtual gift card 12. Computer readable code 14 may also include information about the terms and conditions for using virtual gift card 12 determined by the credit card company.

In one embodiment, computer readable code 14 may be encoded, encrypted or protected with a password for security. Virtual gift card 12 may be designed to require a recipient of virtual gift card 12 to enter a password in order to redeem virtual gift card 12. Other types of security may also be used to control redemption of virtual gift card 12. Computer readable code 14 may include data related to a gift card value corresponding to virtual gift card 12. The gift card value is the monetary amount that virtual gift card 12 may be redeemed for. This value may be determined by a purchaser of virtual gift card 12. Additionally, computer readable code 14 may be designed for one-time use or for multiple uses. Virtual gift card 12 may be loaded with a set amount of funds and can be used for multiple purchases for as long as value remains on virtual gift card 12. The credit card company that provides virtual gift card 12 may allow additional funds to be added later.

In an exemplary embodiment, system 10 includes gift card server 16 in communication with the system elements via communications network 18. Gift card server 16 may be communicatively coupled to communication network 18, wirelessly or by wire or optical fiber. Communication network 18 may include a cellular communication network and the Public Switched Telephone Network (PSTN), or other wide area network (WAN), such as the Internet, as well as local area networks (LANs), such as an Ethernet LAN. Communications network 18 may be a wireless network, such as Wi-Fi, satellite, infrared, Bluetooth, Near Field Communications, or other communications network.

Gift card server 16 may be associated with a third party, such as a national financial institution, banking institution and a credit card company. In an exemplary embodiment, gift card server 16 may be associated with a national financial institution, such as Visa®, MasterCard®, American Express®, Discover® or a bank. Gift card server 16 may store information that may be associated with virtual gift card 12, such as a video file, an audio file, a text file, and a multimedia file. Gift card server 16 may also store information related to merchants, such as the name of the merchant and the type of merchandise or services provided by the merchant. Exemplary merchants may include restaurants, retail stores, entertainment establishments, theaters, beauty salons, hotels, travel agencies, or any business that offers goods or services. Gift card server 16 may store a list of merchants associated with the national financial institution that issued virtual gift card 12.

Gift card server 16 may also be communicatively coupled to other computers via communications network 18, such as computer 20. In an exemplary embodiment, computer 20 may be the home computer of a purchaser of virtual gift card 12. Computer 20 may be a laptop, a desktop computer, a portable computing device, or a personal digital assistant. In another exemplary embodiment, computer 20 may be a computer located at a merchant store. Customers at the merchant store may use computer 20 to purchase virtual gift card 12. Computer 20 may also be located at a national financial institution, such as at a bank or a bank's financial servicing company, and may be used by customers of the bank to purchase virtual gift card 12.

Computer 20 receives input from the purchaser of virtual gift card 12 that may include a redemption value of virtual gift card 12, as well as a design template selected by the purchaser for association with virtual gift card 12. The design template may be, for example, a birthday or holiday template. The design template may include credit card company information, such as a telephone number of the financial institution associated with virtual gift card 12. The recipient of virtual gift card 12 may contact the financial institution that issued the card with questions regarding redemption of virtual gift card 12. The design template may also include activation instructions provided by the financial institution, such as a credit card company, associated with virtual gift card 12. The financial institution may activate virtual gift card 12 automatically upon purchase and may be used immediately. In another embodiment, the financial institution may require virtual gift card 12 to be activated by the recipient before they can be used. Computer 20 sends to gift card server 16, via communication network 18, a request to generate virtual gift card 12 based on the input received from the purchaser of virtual gift card 12.

Gift card server 16 receives the request from computer 20 and generates virtual gift card 12 in response to receiving the request from computer 20. Gift card server 16 may generate virtual gift card 12 using at least one of a plurality of inputs received. Gift card server 16 may use communications network 18 to transmit the generated virtual gift card 12 to a recipient, by for example, transmitting virtual gift card 12 to a recipient's email, telephone number, social media identification or transmitting virtual gift card 12 in a text message using Short Message Service (“SMS”). Virtual gift card 12 may also be transmitted to the purchaser of virtual gift card 12, who can then send virtual gift card 12 to a recipient.

In an exemplary embodiment, virtual gift card 12 is sent to wireless mobile device 22 or to a recipient's computer which can subsequently download virtual gift card 12 to wireless mobile device 22. Wireless mobile device 22 may be a smart phone, a computer tablet, a cell phone, a laptop computer, a wireless device, a personal information device, a personal digital assistant, or any device capable of communication with another electronic device. Wireless mobile device 22 may be connected to communications network 18 and may be in communication with point of sale device 26. Wireless mobile device 22 may be coupled to communications network 18 wirelessly or by wire or optical fiber. For example, wireless mobile device 22 may communicate with communications network 18 using Orthogonal Frequency Division Multiplex (OFDM), Code Division Multiple Access (CDMA), Wi-Fi, WiMax, Near Field Communication, or other wireless LAN and/or cellular technology.

System 10 further includes point of sale device 26. Point of sale device 26 may be located at a point of sale in a merchant's store. Point of sale device 26 may have been provided to the merchant by the financial institution associated with virtual gift card 12. Point of sale device 26 may be in communication with wireless mobile device 22 directly via store network 30 or indirectly via communications network 18. A recipient of virtual gift card 12 may wish to redeem virtual gift card 12 at a merchant store that accepts the corresponding financial institution's cards. The recipient may use wireless mobile device 22 to display computer readable code 14 on screen 24, so that point of sale 26 may read computer readable code 14. Point of sale device 26 may include a sensor, an image capturing device, or any device capable of reading or receiving a signal containing computer readable code 14. Point of sale device 26 may read, scan, examine, decode or receive computer readable code 14 using a wired or a wireless medium. Point of sale device 26 may validate computer readable code 14 and apply the value of virtual gift card 12 to a purchase.

In an exemplary embodiment, point of sale device 26 may use an input device, such as scanner 28, to read computer readable code 14 displayed on screen 24 of wireless mobile device 22. Scanner 28 may, for example, be an optical scanner, a laser scanner, a bar code reader, an image-base scanner, or a device capable of reading or receiving encoded data. In another exemplary embodiment, wireless mobile device 22 may transmit computer readable code 14 to point of sale device 26 via communications network 18. For example, wireless mobile device 22 may send computer readable code 14 to point of sale device 26 using a wireless signal, such as a radio frequency signal, Wi-Fi, Bluetooth, Near Field Communication or an infrared signal.

Point of sale device 26 may be connected to store network 30. Store network 30 may include a cellular communication network and the Public Switched Telephone Network (PSTN), or other wide area network (WAN), such as the Internet, as well as local area networks (LANs), such as an Ethernet LAN. Store network 30 may connect point of sale device 26 with other computers, such as merchant computer 32. Merchant store computer 32 may be a wireless device, a laptop computer, a server, or any device capable of communication with another electronic device. Merchant computer 32 may be co-located with point of sale device 26 or may be located at a remote location. Merchant computer 32 may be in communication with gift card server 16 via store network 30 and communications network 18. Merchant computer 32 may be associated with a financial institution, such as a national credit card company.

Point of sale device 26 may send computer readable code 14 to one of merchant computer 32 and gift card server 16. Point of sale device 26, merchant computer 32 or gift card server 16 may validate virtual gift card 12 by analyzing computer readable code 14. For example, point of sale device 26, merchant computer 32 or gift card server 16 may determine the redemption value of virtual gift card 12 and may apply the value as at least partial payment for a purchase.

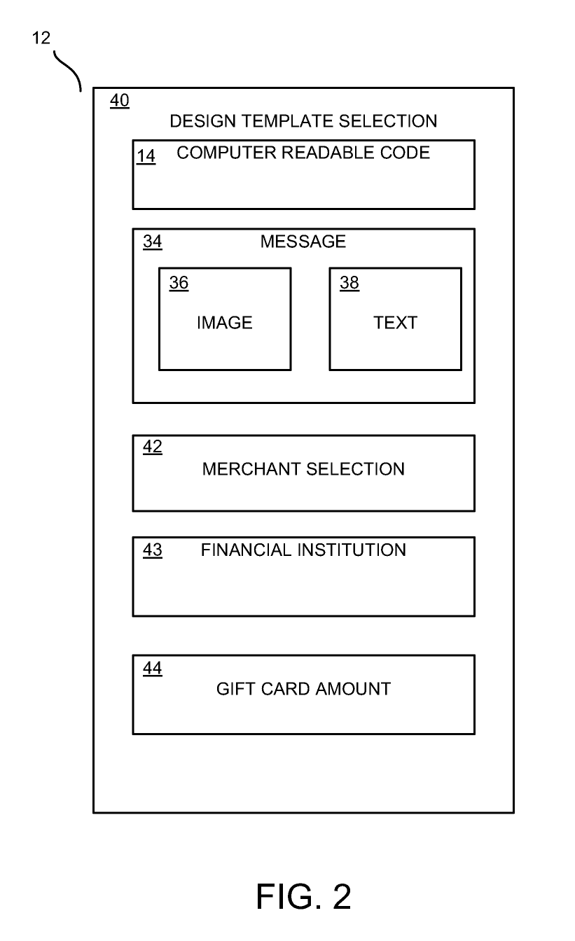

FIG. 2 is a diagram of an exemplary virtual gift card constructed in accordance with the principles of the present invention. A purchaser of virtual gift card 12 may want to associate a customizable message 34, such as a birthday greeting, with virtual gift card 12. Message 34 may include graphical elements, such as image 36. Image 36 may include a photograph selected by the purchaser of virtual gift card 12, a logo, artwork, seasonal graphics, special occasion designs and festive graphics. Image 36 may also include graphics and designs associated with a financial institution, such as the Visa® or MasterCard® logo. Message 34 may further be customized to include music, video, images, a multimedia presentation, a link to a website, a voice recording, an advertisement or a coupon. In an exemplary embodiment, image 36 may be accompanied by text 38, which may include a personalized message, a poem, a greeting, etc. Additionally, text 38 may include a recipient name, a recipient's telephone number, a name of a merchant and a recipient's email address.

A purchaser of virtual gift card 12 may customize virtual gift card 12 by selecting a pre-defined design template, a financial institution, and a value to be associated with virtual gift card 12. Gift card server 16 may store a plurality of design templates in a design template database. The design templates may include ornamental or design features which are graphical, colorful and related to a specific holiday, date or event. A purchaser of virtual gift card 12 may choose at least one of the plurality of design templates, such as design template selection 40, for association with virtual gift card 12. Design template selection 40 may include a layout, a color scheme, a theme and a graphical element. In an exemplary embodiment, computer readable code 14 may be integrated into the selected design template. Gift card server 16 may also store a plurality of merchant names in a merchant database. Gift card server 16 may also store information about the financial institution associated with virtual gift card 12.

A purchaser of virtual gift card 12 may select one or more of the plurality of merchants and one or more of the multiple financial institutions to associate with virtual gift card 12, such as merchant selection 42 and financial institution 43. Merchant selection 42 may include one or more of a plurality of merchant selections available. Financial institution 43 may include one or more of the multiple financial institutions selections available, such as Visa®, MasterCard®, American Express®, etc. A recipient of virtual gift card 12 may redeem virtual gift card 12 at merchants associated with the one or more financial institutions selected. For example, if virtual gift card 12 is associated with MasterCard®, a recipient may redeem virtual gift card 12 at nationwide merchants that accept MasterCard® credit cards. In another exemplary embodiment, virtual gift card 12 may be redeemed at the selected merchant for a predetermined gift card amount 44.

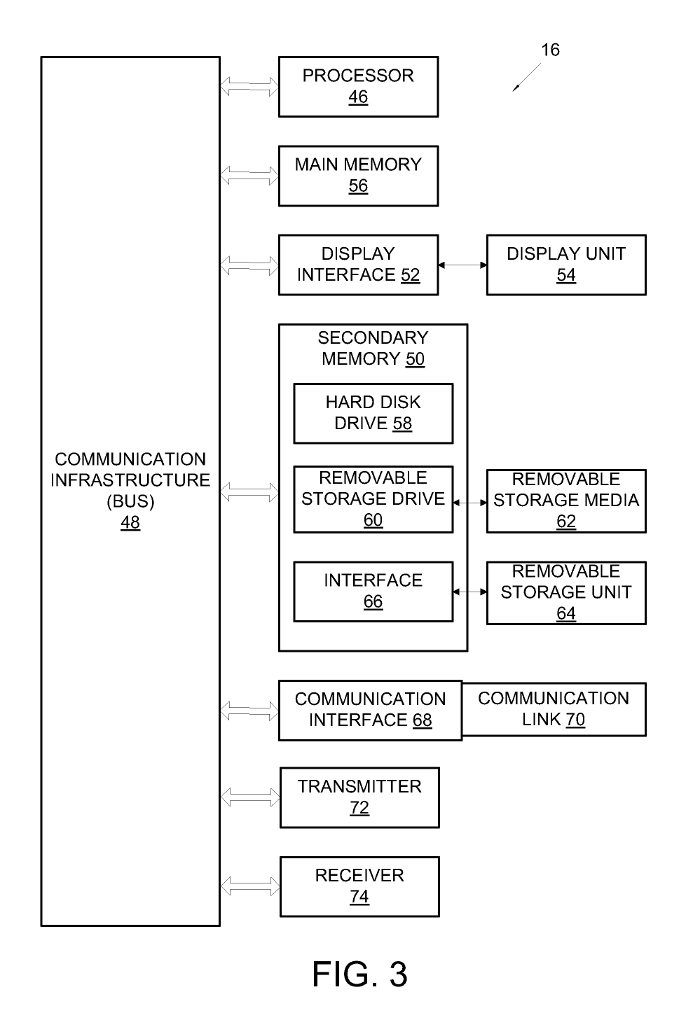

FIG. 3 is a block diagram of an exemplary gift card server 16 constructed in accordance with the principles of the present invention. Gift card server 16 includes one or more processors, such as processor 46 programmed to perform the functions described herein. Processor 46 is operatively coupled to a communication infrastructure 48, e.g., a communications bus, cross-bar interconnect, network, etc. Processor 46 may execute computer programs stored on disk storage for execution via secondary memory 50. Various software embodiments are described in terms of this exemplary computer system. It is understood that computer systems and/or computer architectures other than those specifically described herein can be used to implement the invention. It is also understood that the capacities and quantities of the components of the architecture described below may vary depending on the device, the quantity of devices to be supported, as well as the intended interaction with the device. For example, configuration and management of gift card server 16 may be designed to occur remotely by web browser. In such case, the inclusion of a display interface and display unit may not be required.

Gift card server 16 may optionally include or share a display interface 52 that forwards graphics, text, and other data from the communication infrastructure 48 (or from a frame buffer not shown) for display on the display unit 54. The computer system also includes a main memory 56, such as random access memory (“RAM”) and read only memory (“ROM”), and may also include secondary memory 50. Secondary memory 50 may include, for example, a hard disk drive 58 and/or a removable storage drive 60, representing a removable hard disk drive, magnetic tape drive, an optical disk drive, etc. The removable storage drive 60 reads from and/or writes to a removable storage media 62 in a manner well known to those having ordinary skill in the art. Removable storage media 62, represents, for example, a floppy disk, external hard disk, magnetic tape, optical disk, etc. which is read by and written to by removable storage drive 60. As will be appreciated, the removable storage media 62 includes a computer usable storage medium having stored therein computer software and/or data.

In alternative embodiments, secondary memory 50 may include other similar devices for allowing computer programs or other instructions to be loaded into the computer system and for storing data. Such devices may include, for example, a removable storage unit 64 and an interface 66. Examples of such may include a program cartridge and cartridge interface (such as that found in video game devices), flash memory, a removable memory chip (such as an EPROM, EEPROM or PROM) and associated socket, and other removable storage units 64 and interfaces 66 which allow software and data to be transferred from the removable storage unit 64 to other devices.

Gift card server 16 may also include a communications interface 68. Communications interface 68 allows software and data to be transferred to external devices. Examples of communications interface 68 may include a modem, a network interface (such as an Ethernet card), a communications port, a PCMCIA slot and card, wireless transceiver/antenna, etc. Software and data transferred via communications interface/module 68 may be, for example, electronic, electromagnetic, optical, or other signals capable of being received by communications interface 68. These signals are provided to communications interface 66 via the communications link (i.e., channel) 70. Channel 70 carries signals and may be implemented using wire or cable, fiber optics, a phone line, a cellular phone link, an RF link, and/or other communications channels.

It is understood that gift card server 16 may have more than one set of communication interface 68 and communication link 70. For example, gift card server 16 may have a communication interface 68/communication link 70 pair to establish a communication zone for wireless communication, a second communication interface 68/communication link 70 pair for low speed, e.g., WLAN, wireless communication, another communication interface 68/communication link 70 pair for communication with low speed wireless networks, and still another communication interface 68/communication link 70 pair for other communication.

Computer programs (also called computer control logic) are stored in main memory 56 and/or secondary memory 50. For example, computer programs are stored on disk storage, i.e. secondary memory 50, for execution by processor 46 via RAM, i.e. main memory 56. Computer programs may also be received via communications interface 68. Such computer programs, when executed, enable the method and system to perform the features of the present invention as discussed herein. In particular, the computer programs, when executed, enable processor 46 to perform the features of the corresponding method and system. Accordingly, such computer programs represent controllers of the corresponding device.

Gift card server 16 also includes transmitter 72 and receiver 74. Processor 46 communicates with transmitter 72 and receiver 74 via communication infrastructure 48. Gift card server 16 may be associated with a financial institution, such as a credit card company. A purchaser of virtual gift card 12 may use computer 20 to request gift card server 16 to generate virtual gift card 12. The purchaser of virtual gift card 12 may select a design template, a financial institution and a merchant to associate with virtual gift card 12. Additionally, the purchaser of virtual gift card 12 may use computer 20 to select a value amount for virtual gift card 12. Receiver 74 may receive the request to generate virtual gift card 12 along with a set of inputs, such as design template selection 40, merchant selection 42, financial institution 43 and gift card amount 44.

Processor 46 may generate virtual gift card 12 based on the set of inputs, such as design template selection 40, merchant selection 42, financial institution 43 and gift card amount 44. Processor 46 generates virtual gift card 12 to include computer readable code 14, and may activate virtual gift card 12 for redemption at multiple nationwide merchants that accept cards provided by financial institution 43 in an amount corresponding to gift card amount 44. Processor 46 may activate virtual gift card 12 for redemption at a websites of participating merchants associated with financial institution 43, i.e. merchants that accept forms of payment associated with the financial institution, in an amount corresponding to the gift card amount. Transmitter 72 sends the generated virtual gift card 12 to a recipient specified by the purchaser of virtual gift card 12. Transmitter 72 may send the generated virtual gift card 12 to a recipient's email, telephone number or social media identification. In an exemplary embodiment, transmitter 72 sends virtual gift card 12 to wireless mobile device 22. Transmitter 72 may also send gift card amount 44 to merchant computer 32, computer 20, or any other party.

The recipient of virtual gift card 12 receives virtual gift card 12 from gift card server 16. To redeem virtual gift card 12, recipient may use wireless mobile device 22 to display computer readable code 14 on screen 24 of wireless mobile device 22. Point of sale device 26 may read, scan, receive, decode, or examine computer readable code 14 displayed on screen 24. Point of sale device 26 may send computer readable code 14 to gift card server 16 via communications network 18 for validation. Receiver 74 may receive computer readable code 14 and processor 46 may validate computer readable code 14. A validation message may be sent by transmitter 72 to point of sale device 26 authorizing point of sale device 26 to apply gift card amount 44 as at least partial payment for a purchase.

Additionally, transmitter 72 may send purchase information associated with the purchase to wireless mobile device 22 in response to receiver 74 receiving computer readable code 14. Information associated with the purchase may include, for example, a coupon, a suggested purchase, a cash-back incentive or a gift with purchase certificate. In an exemplary embodiment, transmitter 72 may send purchase information associated with the purchase to merchant computer 32 or point of sale device 26 for validation.

In another exemplary embodiment, the recipient may wish to make an online purchase at a merchant website. The merchant website may be associated with financial institution 43 and may accept credit cards issued by financial institution 43 as a form of payment. By way of example, a merchant website that takes Visa® credit cards as a form of payment may also accept virtual gift card 12 associated with Visa®, i.e. Visa® is financial institution 43. The recipient may wish to redeem virtual gift card 12 and apply gift card amount 44 as at least partial payment for the online purchase. The recipient may use wireless mobile device 22 or a computer connected to the Internet to redeem virtual gift card 12 at a merchant website. Wireless mobile device 22 or the computer connected to the Internet may send computer readable code 14 to gift card server 16 via communications network 18 for validation. Receiver 74 may receive computer readable code 14 and processor 46 may validate computer readable code 14. The merchant website may receive an authorization to apply gift card amount 44 as at least partial payment for a purchase. The merchant website may receive authorization from a computer associated with financial institution 43. In an exemplary embodiment, gift card server 16 or merchant computer 32 may be associated with financial institution 43. Gift card server or merchant computer 32 may send an authorization message to the merchant website to apply gift card amount 44 as at least partial payment for a purchase. The merchant website may display computer readable code 14 and apply gift card amount 44 as at least partial payment for the online purchase at the merchant website.

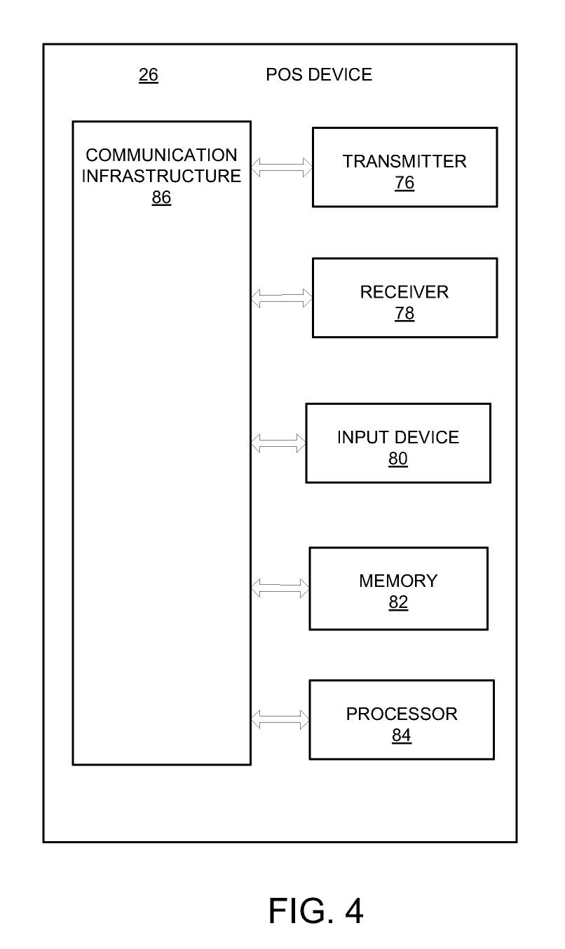

FIG. 4 is an exemplary point of sale device 26 in accordance with the principles of the present invention. Point of sale device may include transmitter 76, receiver 78, input device 80, memory 82, and processor 84, all connected via communication infrastructure 86. Communication infrastructure 86 may be a communications bus, cross-bar interconnect, network, etc. Point of sale device 26 may be positionable at a point of sale at a merchant store and may be configured to redeem virtual gift card 12. In an exemplary embodiment, input device 80 reads computer readable code 14 displayed on screen 24 of wireless mobile device 22. Receiver 78 receives computer readable code 14. Computer readable code 14 may be validated by processor 84, so that virtual gift card 12 can be used to at least partially pay for a purchase. Transmitter 76 may transmit computer readable code 14 to merchant computer 32, gift card server 16, or another party for further analysis, validation, record keeping, etc. Receiver 78 may receive a validation message from one of gift card server 16 and merchant computer 32, wherein at least one of gift card server 16 and merchant computer 32 may be associated with financial institution 43, authorizing point of sale device 26 to apply gift card amount 44 as at least partial payment for a purchase.

Further, transmitter 76 may send data associated with computer readable code 14 to merchant computer 32 and gift card server 16. The data associated with computer readable code 14 may be a purchase price, a description of the goods or services purchased, a date of purchase, etc. In an exemplary embodiment, receiver 78 may receive information associated with virtual gift card 12 from at least one of gift card server 16 and merchant computer 32. Information associated with virtual gift card 12 may include a name of the recipient of virtual gift card 12, a coupon for future purchases, etc. Transmitter 76 may send purchase information such as, a purchase price, a picture of the good or service purchased and a purchase date and time to a social media website for association of the purchase with a social media identification corresponding to the recipient of virtual gift card 12.

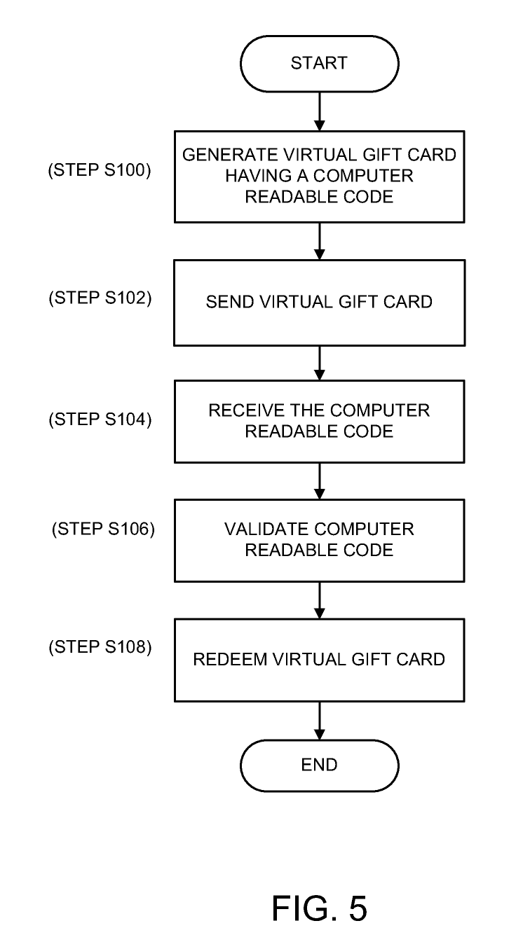

FIG. 5 is a flow chart of an exemplary method for generating and redeeming virtual gift card 12 according to the principles of the present invention. A virtual gift card 12 having computer readable code 14 is generated (Step S100). Computer readable code 14 corresponds to gift card amount 44. Virtual gift card 12 is sent to a recipient (Step S102). Computer readable code 14 may be received (Step S104) at point of sale device 26. Computer readable code 14 is validated (Step S106) so that virtual gift card 12 can be redeemed at a point of sale (Step S108) by applying gift card amount 44 as at least partial payment for a purchase.

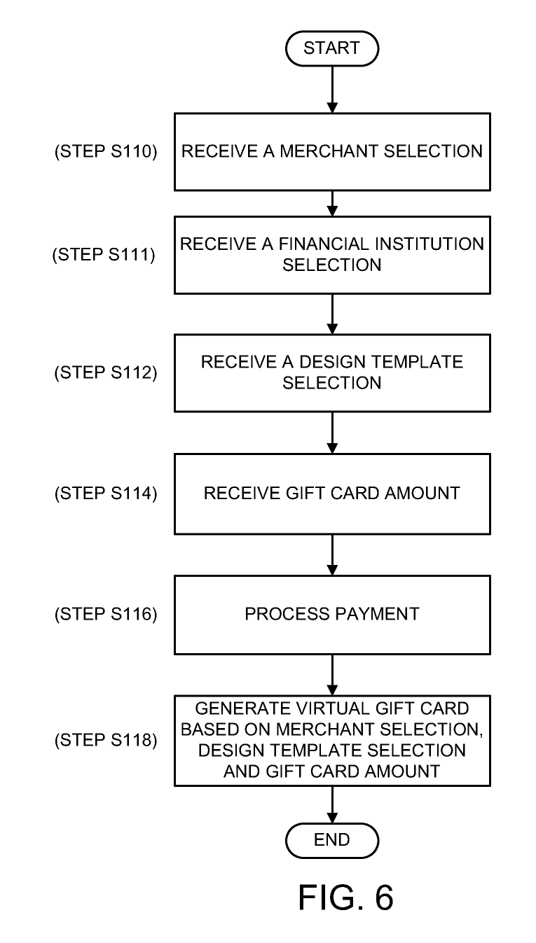

FIG. 6 is a flow chart of an exemplary method for generating virtual gift card 12 according to the principles of the present invention. A purchaser may decide to buy virtual gift card 12 and may select a merchant, a financial institution, a design template and a value to associate with virtual gift card 12. A merchant selection 42associated with virtual gift card 12 is received (Step S110). Merchant selection 42 may include the name of a merchant where virtual gift card 12 may be redeemed. A financial institution 43 selection associated with virtual gift card 12 may be received (Step S111). Financial institution 43 may include the name of the financial institution. The financial institution may be a credit card company. Virtual gift card 12 may be redeemable at nationwide merchants associated with financial institution 43. A design template selection associated with virtual gift card 12 is also received (Step S112). The design template selected may be a special event template, such as a birthday template. Gift card amount 44 associated with virtual gift card 12 is received (Step S114). Gift card amount 44 corresponds to a redemption value of virtual gift card 12. The purchaser of virtual gift card 12 submits payment information to pay for virtual gift card 12. Payment is processed (Step S116) and virtual gift card 12 is generated based on the selected merchant, the selected financial institution 43, the selected design template and gift card amount 44 (Step S118).

In one embodiment, the purchaser of virtual gift card 12 may purchase virtual gift card 12 at a website associated with financial institution 43, like the MasterCard® website. The purchaser may select a design template and gift card amount 44. Virtual gift card 12 may be generated for redemption at merchants that accept cards provided by financial institution 43, for example, MasterCard®.

The present invention can be realized in hardware, or a combination of hardware and software. Any kind of computing system, or other apparatus adapted for carrying out the methods described herein, is suited to perform the functions described herein. A typical combination of hardware and software could be a specialized computer system, e.g., a point of sale terminal, having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language or notation, of a set of instructions intended to cause a system having an information processing capability to perform a particular function either directly or after either or both of the following a) conversion to another language, code or notation; b) reproduction in a different material form.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

1. A method, comprising:
generating a virtual gift card associated with a financial institution, the virtual gift card having a computer readable code corresponding to a gift card amount;
sending the virtual gift card to a recipient, the virtual gift card being redeemable at merchants that accept forms of payment associated with the financial institution; and
receiving the computer readable code from a wireless mobile device at a point of sale, the corresponding gift card amount being applied as at least partial payment for a purchase.

2. The method of claim 1, further comprising scanning the computer readable code displayed on a screen of the wireless mobile device at the point of sale.

3. The method of claim 1, wherein sending the virtual gift card to the recipient includes sending the virtual gift card to one of an email address, a wireless mobile device number, and a social media identification associated with the recipient.

4. The method of claim 1, further comprising:
associating the virtual gift card with a message, the message comprising at least one of an image and a personalized text, the image including a design associated with the financial institution; and sending the message to the recipient.

5. The method of claim 1, wherein generating the virtual gift card includes:
receiving a set of inputs including a financial institution selection, a design template selection, and the gift card amount;
generating the virtual gift card based on the set of inputs; and
activating the virtual gift card for redemption at merchants associated with the selected financial institution in an amount corresponding to the gift card amount.

6. The method of claim 5, further comprising sending the gift card amount to a computer associated with the financial institution.

7. The method of claim 5, wherein the selected design template integrates the computer readable code on part of a design.

8. A system, comprising:
a gift card server, the gift card server including:
a processor, the processor generating a virtual gift card associated with a financial institution, the virtual gift card having a computer readable code corresponding to a gift card amount and being redeemable at merchants that accept forms of payment associated with the financial institution;
a transmitter in communication with the processor, the transmitter sending the virtual gift card to a recipient; and
a receiver in communication with the processor, the receiver receiving the computer readable code from a wireless mobile device at a point of sale, the corresponding gift card amount being applied as at least partial payment for a purchase.

9. The system of claim 8, wherein the transmitter further sends purchase information to the wireless mobile device in response to the receiver receiving the computer readable code.

10. The system of claim 8, wherein sending the virtual gift card to the recipient includes sending the virtual gift card to one of an email address, a wireless mobile device number, and a social media identification associated with the recipient.

11. The system of claim 8, wherein the processor further:
associates the virtual gift card with a message, the message comprising at least one of an image and a personalized text, the image including a design associated with the financial institution; and
the transmitter further sends the message to the recipient.

12. The system of claim 8, further comprising a merchant computer in communication with the gift card server, wherein the transmitter further sends the gift card amount to the merchant computer in response to the gift card server receiving the computer readable code, the merchant computer operating to validate the purchase, the merchant computer being associated with the financial institution.

13. The system of claim 8, wherein generating the virtual gift card includes receiving a set of inputs including a financial institution selection, a design template selection, and the gift card amount; and the processor further:
generates the virtual gift card based on the set of inputs; and
activates the virtual gift card for redemption at merchants associated with the selected financial institution in an amount corresponding to the gift card amount.

14. The system of claim 13, wherein the selected design template integrates the computer readable code on part of a design.

15. A point of sale device, comprising:
a receiver, the receiver positionable at a point of sale at a merchant store, the receiver receiving a computer readable code from a wireless mobile device as at least partial payment for a purchase, the computer readable code associated with a virtual gift card, the computer readable code corresponding to a gift card amount, the virtual gift card being associated with a financial institution and being redeemable at a plurality of merchants associated with the financial institution.

16. The point of sale device of claim 15, wherein the computer readable code includes payment information corresponding to the gift card amount.

17. The point of sale device of claim 15, further comprising a transmitter in communication with the receiver, the transmitter sending purchase information to the wireless mobile device in response to receiving the computer readable code.

18. The point of sale device of claim 15, further comprising a transmitter in communication with the receiver, the transmitter sending data associated with the computer readable code to a merchant computer to validate the purchase, the merchant computer being associated with the financial institution.

19. The point of sale device of claim 18, wherein the receiver further receives an authorization to accept the virtual gift card as payment for the purchase from the merchant computer.

20. The point of sale device of claim 18, wherein the transmitter further sends purchase information to a social media website that associates the purchase with a social media identification of the recipient.

21. A method, comprising:
generating a virtual gift card associated with a financial institution, the virtual gift card having a computer readable code corresponding to a gift card amount;
sending the virtual gift card to a wireless mobile device, the virtual gift card being redeemable at merchants that accept forms of payment associated with the financial institution; and
receiving, at a point of sale, the computer readable code from one of the wireless mobile device and a computer connected to the Internet, the corresponding gift card amount being applied as at least partial payment for an online purchase.

22. The method of claim 21, wherein generating the virtual gift card includes:
receiving a set of inputs including a financial institution selection, a design template selection, and the gift card amount;
generating the virtual gift card based on the set of inputs; and
activating the virtual gift card for redemption at a website of a merchant associated with the selected financial institution in an amount corresponding to the gift card amount.

23. The method of claim 22, wherein the merchant website displays the computer readable code being applied as at least partial payment for the online purchase at the merchant website.

24. A system, comprising:
a gift card server, the gift card server including:
a processor, the processor generating a virtual gift card associated with a financial institution, the virtual gift card having a computer readable code corresponding to a gift card amount;
a transmitter in communication with the processor, the transmitter sending the virtual gift card to a wireless mobile device, the virtual gift card being redeemable at merchants that accept forms of payment associated with the financial institution; and
a receiver in communication with the processor, the receiver receiving the computer readable code from one of the wireless mobile device and a computer connected to the Internet, the corresponding gift card amount being applied as at least partial payment for an online purchase.
